(19) United States
(12) Patent Application Publication
(10) Pub. No.: US 2022/0207507 A1
(43) Pub. Date: Jun. 30, 2022

(54) Automatic Creation of Master Catalog and Catalog Map for Reconciliation of Merchant Point-of-Sale Catalog and Third-Party Service Catalog

(71) Applicant: Your Fare, Inc., Austin, TX (US)

(72) Inventors: Charles Robert Berg, Las Vegas, NV (US); Minghan Zhu, New York, NY (US); Christopher David Monk, Austin, TX (US)

(21) Appl. No.: 17/138,683

(22) Filed: Dec. 30, 2020

(51) Int. Cl. G06Q 20/20; G06F 16/22; G06N 20/00

(52) U.S. Cl. CPC G06Q 20/202; G06Q 30/0603; G06N 20/00; G06F 16/2246

(57) ABSTRACT

Provided are methods and systems for automatic creation of a catalog map for reconciliation of a merchant catalog, as used in a merchant point-of-sale system and a third-party reseller catalog configured to receive an order from a consumer for one or more items from the merchant. The disclosed invention provides for extraction of a merchant catalog and at least one reseller catalog for the merchant from a third-party reseller service. Subsequently, terms are compared between the extracted catalog using an automatic three-tiered approach consisting of pattern (or string) based mapping, structure based mapping into a hierarchical model, and semantic based matching. From this, a hierarchical catalog map is generated for equivalent terms between the two extracted catalog. The catalog map can then be used to create a new Master Catalog.

### CROSS-REFERENCE TO RELATED APPLICATIONS

N/A

### FIELD OF THE TECHNOLOGY

This application relates generally to artificial intelligence and machine learning methodologies for automatically creating a master catalog and catalog map to correlate multiple listings of offerings provided by a business with one another.

### BACKGROUND

These days there can be multiple avenues for a person to order items from a merchant without being physically present in a merchant store—the person can call the merchant directly, place an order through the merchant's own website, or place an order through a website or mobile application of a third-party reseller. In the case of restaurants, third-party reseller can be such companies as GrubHub, DoorDash, Postmates, UberEats, waiter.com. Typically, the third-party resellers create online catalogs for the merchant without coordinating with a merchant's own point-of-sale system. Thus, a given item may be represented completely differently in a merchant's point-of-sale system than in a catalog created by a third-party reseller.

Further, each third-party reseller creates their own catalog, so there may be multiple versions of a merchant's catalog available online. Thus, there exists a need to correlate an item from a merchant catalog of each third-party reseller to the items listed by the merchant's own point of sale system such that the merchant can track and charge each item appropriately.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Provided are methods and systems for automatically creating a catalog map between a third-party catalog for a merchant and the merchant's own catalog in its point-of-sale system. In one industry-specific implementation, a merchant is a restaurant, and a merchant catalog is a menu. In some embodiments, a system for automatic creation of a catalog map comprises a catalog extraction unit configured to extract a third-party catalog for a merchant from a third-party service; and extract a merchant catalog from a merchant point-of-sale system. The system also comprises a catalog map creation unit that is configured to utilize machine learning methods to build a multi-tier hierarchical model for the extracted third-party catalog; build a multi-tier hierarchical model for the extracted merchant catalog; compare at least one term from the extracted third-party catalog with at least one term from the extracted merchant catalog; determine an equivalence between two compared terms; and generate a catalog map in the hierarchical model structure with each item on the third-party catalog mapped to a corresponding item on the merchant catalog.

With the disclosed methods and systems, multiple tasks can be automatically performed. First, the disclosed system can create a catalog map allowing a connected system to receive an incoming merchant order based on a third-party catalog and convert it to the merchant's POS catalog. Second, the disclosed system can convert one or more catalogs into a new data format that better represents meaningful information. Third, the system can merge two or more catalogs into a single catalog that is a proper set of all.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Exemplary embodiments are illustrated by way of example and not limitation in the figures of the accompanying drawings, in which like references indicate similar elements.

FIG. 1 depicts an exemplary catalog map.

FIG. 2 depicts an exemplary graphical user interface of a POS manager utility.

FIG. 3 depicts an exemplary catalog model.

FIG. 4 depicts an exemplary embodiment of one to one catalog mapping.

FIG. 5 depicts an exemplary embodiment of one to many catalog mapping.

FIG. 6 depicts an exemplary embodiment of many to one catalog mapping.

FIG. 7 depicts an exemplary sequence of mapping rules.

FIG. 8 depicts an exemplary process to find a best match between two terms.

FIG. 9 depicts another exemplary process to find a best match between two terms.

FIG. 10 depicts an exemplary process for comparing two terms.

FIG. 11 depicts an exemplary machine learning process to automatically create a catalog map.

FIG. 12 depicts an exemplary environment for embodiments discussed herein.

FIG. 13 depicts an exemplary system for automatic creation of catalog maps.

FIG. 14 depicts an exemplary computing system that may be used to implement embodiments described herein.

FIG. 15 depicts an exemplary structure of a master catalog that may be created by system from a merged catalog model.

FIG. 16 depicts an exemplary flowchart for creating a merged catalog model.

FIG. 17 depicts an exemplary methodology for automatically creating a catalog map.

FIG. 18 depicts an exemplary graphical user interface of a tool to apply modifiers to master catalog item properties.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, and other embodiments can be formed, by introducing structural and logical changes without departing from the scope of what is claimed. The following detailed description is, therefore, not to be taken in a limiting sense and the scope is defined by the appended claims and their equivalents.

In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The embodiments disclosed herein may be implemented using a variety of technologies. For example, the methods described herein may be implemented in software executing on a special purpose computer system containing one or more computers, or in hardware utilizing either a combination of microprocessors or other specially designed application-specific integrated circuits (ASICs), programmable logic devices, or various combinations thereof. In particular, the methods described herein may be implemented by a series of computer-executable instructions residing on a storage medium, such as a disk drive, or computer-readable medium.

Disclosed herein are artificial intelligence and machine learning methodologies for translating multiple versions of a listing of offerings provided by a business with one another. More specifically, a three-tiered approach is disclosed, consisting of pattern (or string) based mapping of text, structure based mapping utilizing data organized into a hierarchical model, and semantic based matching (parts of speech, synonyms, etc.). In one exemplary embodiment discussed throughout this disclosure, a catalog map adapted for the restaurant industry in the form of a menu map is automatically created to correlate items on a menu provided by a restaurant merchant with items on a different version of the restaurant's menu (catalog) that is provided by a third-party service, also sometimes referred to herein as a third-party reseller or an online ordering company.

Every merchant's catalog has the possibility to be unique from every other merchant's catalog, so Point-of-sale (POS) System companies allow each merchant to configure their own catalog in their system. This is usually done by a technical person who understands the complexities of the POS System. Online ordering companies also allow each merchant to configure their own catalogs in the system. But this is usually done by a marketing person who is trying to make their catalog stand out amongst the competition.

The result is that a food item defined as a “burger” in the POS System might be described as a “Deluxe Burger” on one online ordering site, as a “Super Hamburger” on another, and as simply a “Hamburger” on a third. When attempting to integrate the online ordering services with the merchant POS System, the catalogs from each side must first be converted to a uniform format, and then the specific item names provided by the online ordering company must be “mapped” to the POS System names, so the merchant can prepare and charge the items correctly in each customer's order.

Further, many merchants traditionally utilized cash registers to ring up specific catalog items for each customer's order. Gradually, merchants shifted to utilizing a Point-of-sale (POS) system to ring up catalog items for each customer's order. These POS systems are typically specialized hardware systems with specialized software operating on them. In embodiments of the present disclosure, a POS system can communicate with a cloud server and database for the POS company through an Application Programming Interface (API) to allow the merchant to use dynamic catalogs without having to re-program the specialized hardware of the POS system. Further, the POS system can communicate via an API with a cloud server and database for a separate cataloging and order processing system that provides catalog extraction, catalog translation, catalog merging, and catalog mapping to reconcile the POS catalog with a third-party service catalog. The separate cataloging system may generate and retain a plurality of catalog maps per merchant. Further, the cataloging system can be connected to multiple POS systems, such as for multiple locations of a same merchant.

Embodiments of the present disclosure provide for mechanisms to automatically create a catalog map to map a catalog item from a third-party reseller to a catalog item in a merchant's POS system.

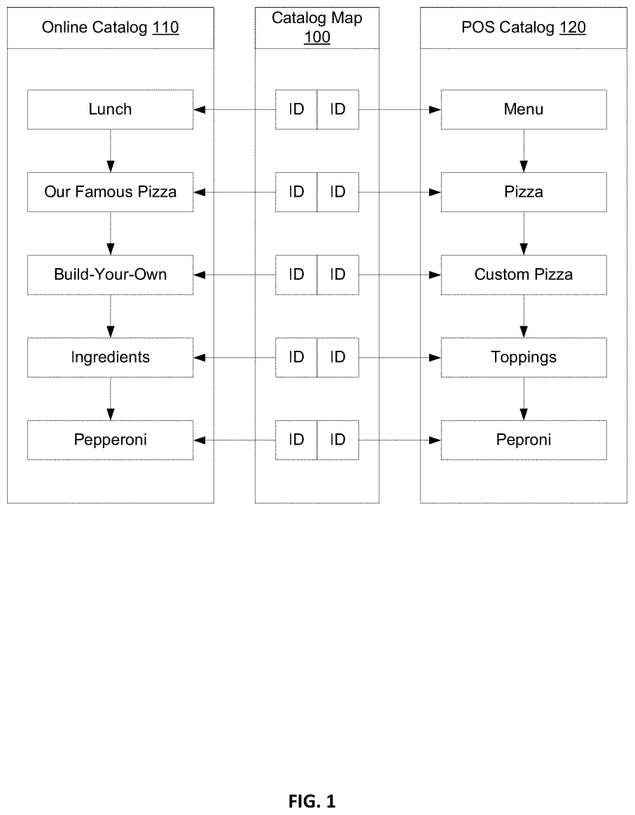

FIG. 1 depicts an exemplary catalog map for the exemplary use case of a restaurant merchant. For this exemplary use case, the catalog map may be referred to as a menu map herein. In the figure, catalog map 100 is created by the disclosed system to correlate specific catalog items from a third-party online ordering company's catalog (depicted as online catalog 110) to a catalog in a merchant POS system (depicted as POS Catalog 120). As discussed herein, a catalog map is a data structure that relates each item in each online catalog 110 with the corresponding item in the POS catalog 120. A unique instance of this catalog map must be created for each combination of Online Catalog and Merchant POS Catalog. In 2019 there were approximately 180 online ordering companies across the country (according to Forbes.com), and more than 1 million restaurants in the US (according to smallbizgenius.net). Thus, the creation of a catalog map to map each individual catalog item for each online ordering company to each individual restaurant merchant can become quite cumbersome for a person to do manually.

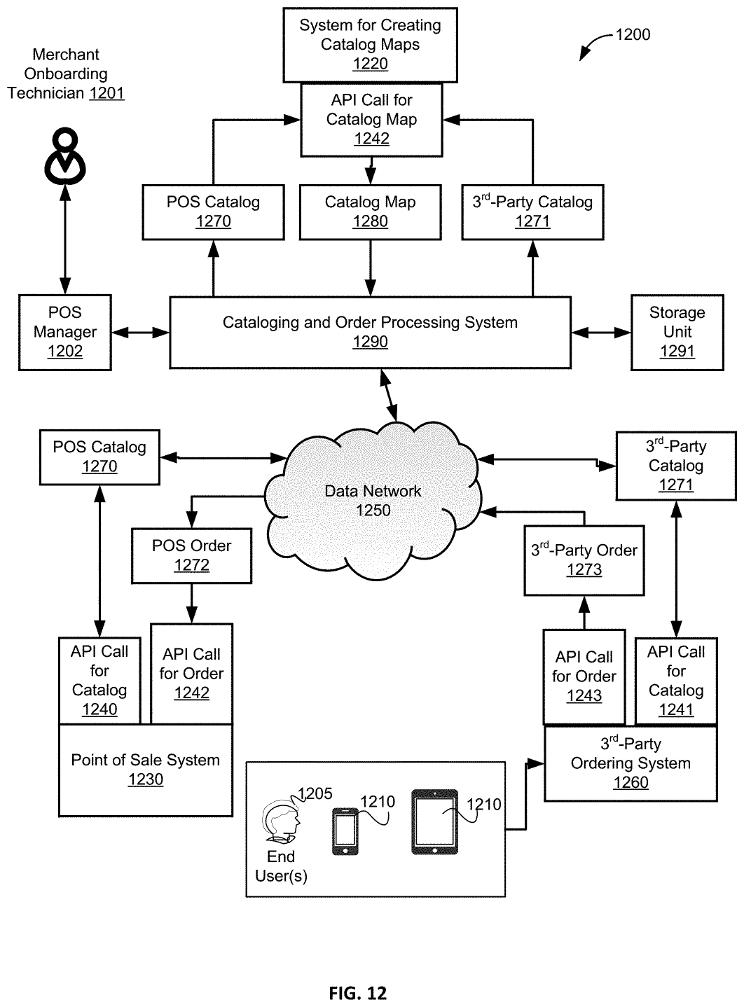

FIG. 12 depicts an exemplary environment 1200 in which the disclosed technology resides. The environment 1200 may include a data network 1250 (e.g., an Internet or a computing cloud), end user(s) 1205, client device(s) 1210 associated with the end user(s) 1205, a point-of-sale system 1230, a system 1220 for automatic creation of catalog maps, and third-party ordering system 1260. Client device(s) 1210 may include a personal computer (PC), a desktop computer, a laptop, a smartphone, smartwatch, a tablet, or any network enabled device.

The data network 1250 may include the Internet or any other network capable of communicating data between devices and/or servers. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a cable modem, an Asynchronous Transfer Mode connection, or a Fiber Distributed Data Interface or Copper Distributed Data Interface connection.

The system for creating catalog maps 1220 may comprise one or more computing servers configured to execute instructions stored in a memory to run one or more computing algorithms and other computing processes to automatically create catalog maps as discussed herein, from a catalog received from the POS system 1230 and a third-party catalog 1271 received over the data network 1250. The system 1220 is in communication with one or more data structure(s) either stored locally or accessible remotely. In one embodiment, a data structure may be a database.

Cataloging and order processing system 1290 may comprise one or more computing servers configured to execute instructions stored in memory to run one or more computing algorithms and other computing processes to perform the functions described herein and communicate via data network 1250.

When a new merchant signs on as a client of cataloging and order processing system 1290, a Merchant Onboarding Technician 1201 performs several tasks to configure a Cataloging and Order Processing System 1290 so that the merchant is recognized as a client. One of those tasks is to create Catalog maps 1280 for each third-party ordering system the merchant partners with. In exemplary embodiments, the Merchant Onboarding Technician 1201 may be a human or a computer.

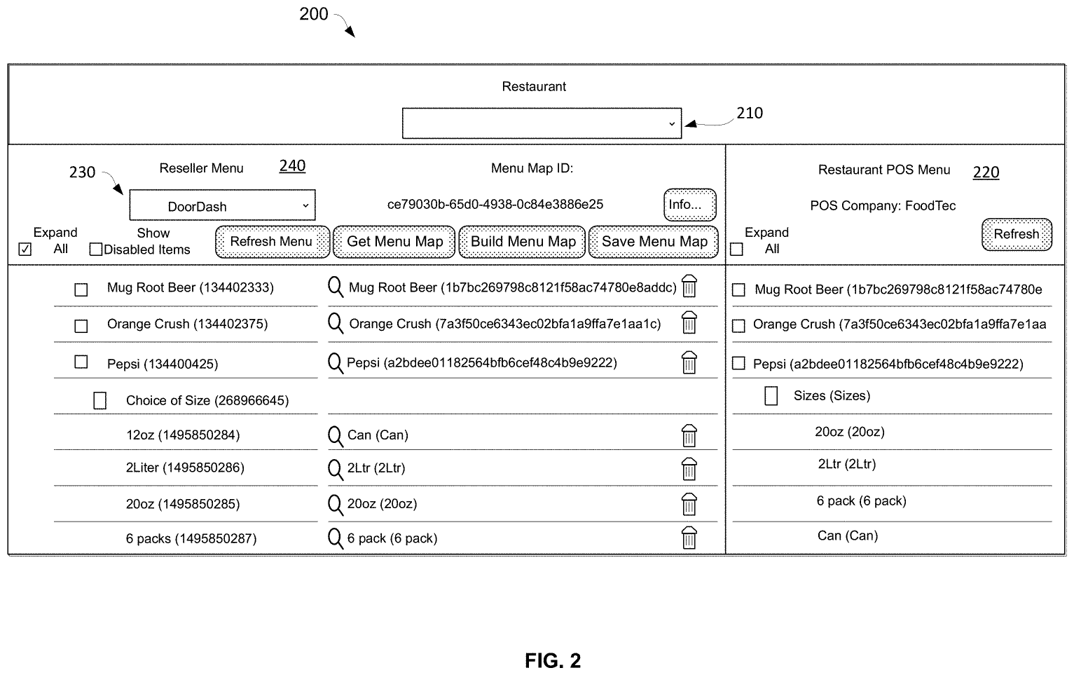

Utilizing the process illustrated in FIG. 2 through FIG. 6, and described herein, one or more Merchant Onboarding Technicians 1201 utilize a POS Manager application 1202 to perform this task. Following the steps described above, the technician 1201 will first acquire a POS Catalog 1270 by directing the Cataloging and Order Processing System 1290 call the API Call for Catalog 1240 connected to the Merchant POS System 1230. The Cataloging and Order Processing System 1290 will automatically save a copy of the retrieved POS Catalog 1270 in the Storage Unit 1291 for future use. Storage Unit 1291 may be a database, or any other data structure.

Second, the technician 1201 acquires a third-party Catalog 1271 by directing the Cataloging and Order Processing System 1290 call the API Call for Catalog 1241 connected to the Third-Party Ordering System 1260. The Cataloging and Order Processing System 1290 will automatically save a copy of the Third-Party Catalog 1271 in the Storage Unit 1291 for future use. As used herein, the API call for catalog 1240 and the API call for catalog 1241 may be conducted by a “catalog extraction unit” of the system 1290.

Third, the technician 1201 acquires a Catalog map 1280 by directing the Cataloging and Order Processing System 1290 call the API Call for Catalog map 1242 sending the POS Catalog 1270 and Third-Party Catalog 1271 to the System for Creating Catalog maps 1220 and getting a Catalog map 1280 in return. The Cataloging and Order Processing System 1290 will automatically save a copy of the Catalog map 1280 in the Storage Unit 1291 for future use.

Optionally, a human technician 1201 may make any required changes to the Catalog map 1280 manually. Finally, technician 1201 directs the Cataloging and Order Processing System 1290 to save the updated Catalog map 1280 in the Storage Unit 1291 for future use.

Upon completing this and any other tasks required to “On Board” the merchant, the Cataloging and Order Processing System 1290 is now ready to accept orders on behalf of the merchant. An End User 1205 is now able to utilize a variety of input devices 1210 to place an order with a Third-Party Ordering System 1260. Through the API Call for Order 1243, Cataloging and Order Processing System 1290 is notified that a Third-Party Order 1273 is available, and it calls to get it.

Upon receiving a new Third-Party Order 1273, Cataloging and Order Processing System 1290 collects the POS Catalog 1270, the Third-Party Catalog 1271, and the Catalog map 1280 associated with the order from the Storage Unit 1291 and converts the Third-Party Order 1273 into a POS Order 1272. Copies of the Third-Party Order 1273 and the POS Order 1272 are saved in the Storage Unit 1291 for future use. And finally, the POS Order 1272 is sent to the POS System 1230 by way of the API Call for Order 1243.

In exemplary embodiments, cataloging and order processing system 1290 may determine that a prior mapping for the particular third-party catalog is not found in storage unit 1291 and automatically run the machine learning algorithms discussed herein to create a catalog map for the particular third-party catalog. In other embodiments, system 1290 may determine that a different third-party catalog is substantially similar to the third-party catalog of the instant order, and utilize its catalog mapping structure to generate a catalog map to be utilized for the instant order.

In some embodiments, the POS Manager 1202 may also direct the Cataloging and Order Processing System 1290 to request that the System for Creating Catalog maps 1220 convert a catalog into a different format, or merge two catalog into one catalog.

FIG. 2 illustrates an exemplary graphical user interface 200 of a POS Manager Utility to assist with managing Catalog maps, such as catalog map 100 of FIG. 1. The figure is for the specific implementation of a restaurant merchant. Selecting a restaurant from the list of available restaurants 210 causes the utility to fetch the restaurant menu from the POS System, and display it on the right-hand side of the screen as Restaurant POS menu 220. As would be understood by persons of ordinary skill in the art, the Restaurant POS menu 220 may be displayed on other portions of the screen instead of on the right side, such as on the left side, in a top panel, in a bottom panel, etc.

Selection of a restaurant also causes the utility to populate a list of Resellers (also sometimes referred to herein as online ordering companies) that are associated with the chosen restaurant. After selecting a reseller from reseller list 230, the restaurant's menu is fetched from the reseller website and displayed on the left-hand side as Reseller Menu 240. If a Menu Map already exists in the system database (such as storage unit 1291 of FIG. 12), it is fetched and displayed in the center column. If none exists yet, an empty map is created and displayed.

In one embodiment of the disclosed utility, a human operator (which may or may not be the technician 1201 from FIG. 12) has the ability to scroll through the reseller menu 240 and the restaurant POS menu 220 to find appropriate matches. When a match is identified, the operator can drag the item from the restaurant POS Menu 220 on the right to the Menu Map in the center, and the appropriate data entry will be made. When all the entries are mapped, the operator can press the Save Menu Map button and save the Menu Map in the database.

In a second embodiment of the disclosed utility, a search function is also provided. The search function is designated by a magnifying glass icon and uses Cosine similarity, Jaro-Winkler distance, and/or Longest Common Subsequence (LCS) algorithms to perform string matching operations between the item names on the reseller menu 240 on the left and the restaurant POS menu 220 on the right to choose candidate matches displayed for selection by the operator. As would be understood by persons of ordinary skill in the art, other algorithms may be used in various embodiments instead of, or in addition to, these listed algorithms.

In a third embodiment of the disclosed utility, the search feature is expanded. Instead of comparing item names one pair at a time, the entire menu is compared one pair of items at a time. This allows the utility to achieve around 80% successful and complete mapping in just a few seconds. The (human) operator reverts to the previous manual process to complete the map.

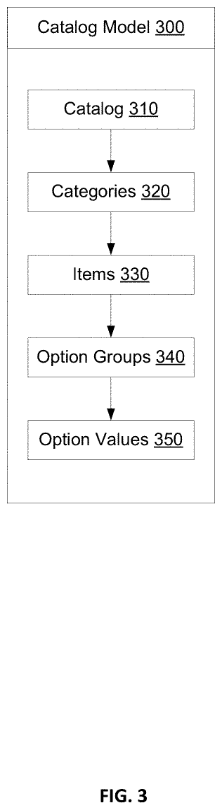

In a fourth embodiment of the disclosed utility, a catalog model is formalized and standardized. An exemplary catalog model 300 is depicted in FIG. 3. By expressing all the POS Catalogs and Online Catalogs in this consistent format, we enable the ability to employ Artificial Intelligence and Machine Learning technologies to the problem of creating Catalog maps fully automatically. By training an inference engine with a library of catalogs, the disclosed system for creating catalog maps (such as system 1220 of FIG. 12) can ingest a new online catalog, compare it to the associated POS catalog, and create a catalog map automatically with near 100% accuracy and completeness.

In exemplary embodiments of the present disclosure, when a catalog is extracted from a POS system, a very explicit data structure is generated that can be algorithmically decomposed into a four level hierarchical catalog model 300 depicted in exemplary FIG. 3. Similarly, when a catalog is received from an online ordering company, a data structure is generated that can be algorithmically decomposed into the four level hierarchical catalog model 300 depicted in exemplary FIG. 3.

As depicted in exemplary FIG. 3, each catalog 310 has a list of categories 320. Exemplary categories for a menu catalog may be appetizers, entrees, salads, desserts, drinks, etc. Within each category 320, there are specific catalog items 330. For example, under an entree category, there may be items such as egg sandwich at breakfast time, hamburger at lunchtime, and filet at dinnertime.

Further, a catalog item 330 can have option groups 340 and options (sometimes referred to herein as option values) 350. As discussed herein, an option group can be a grouping of available ingredients, and an option value a specific ingredient. For example, a catalog item of pizza may have an option group 340 of toppings, and specific option values 350 within that option group 340 that list of specific toppings that are available for the pizza. Further, an option group may be specialty pizza with predetermined combinations of toppings as option values 350.

While not expressly depicted in exemplary FIG. 3, a catalog item 330 may also have a modifier. The modifier is mainly relevant for affecting the price of the item. Modifiers may be associated with catalog items 330, option groups 340, and/or option values 350.

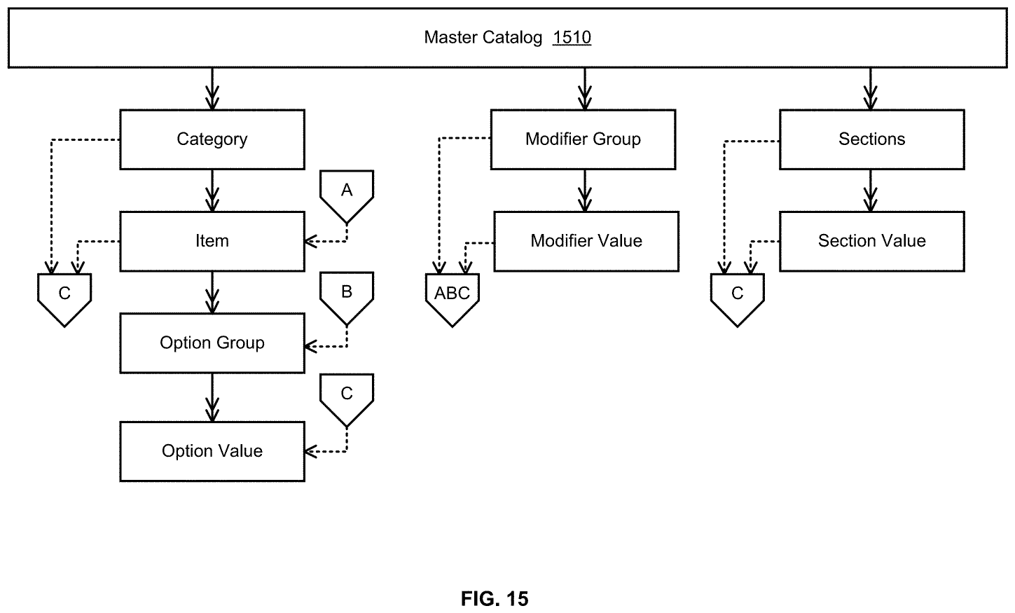

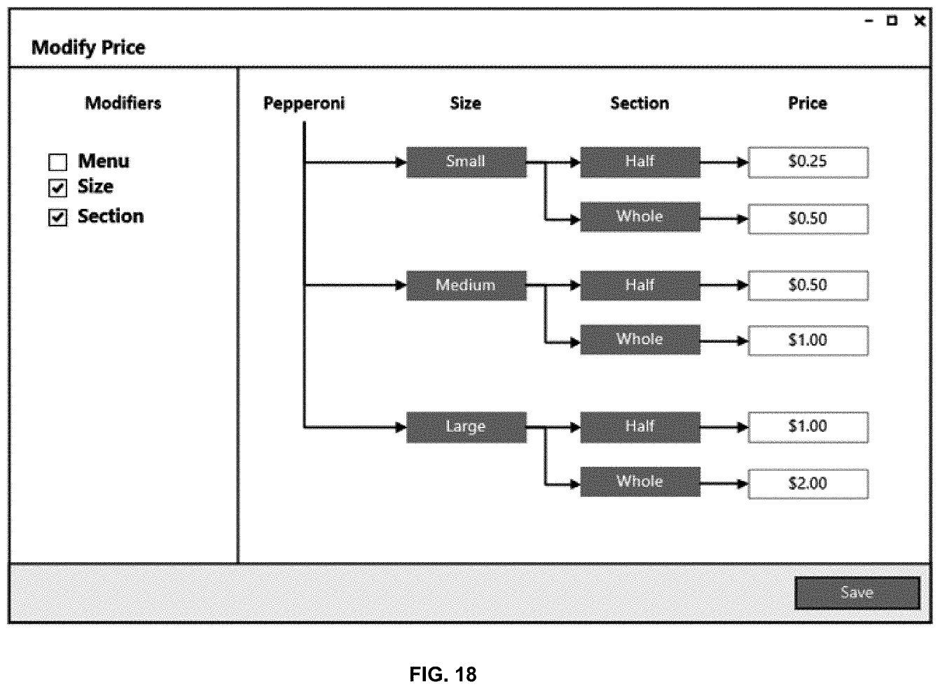

For example, a menu catalog item of pizza may have a modifier for pizza size—small, medium, large, x-large. Further, a menu item of pizza may have a special type of modifier called “Sections” that allows for options (such as toppings) to be applied to either the “left” or “right” section, and to be priced for either a “half” or “whole” order. When converting or merging catalogs, it is important to distinguish between options and modifiers. When a catalog does not incorporate this distinction, the ability to map options to modifiers is particularly important. FIG. 15 depicts this in more detail. Further, FIG. 18 illustrates an exemplary graphical user interface for modifying a price of a topping “pepperoni” based on the size of the pizza and the selection of either a section or the whole pizza. As shown in the figure, the price of the pepperoni option is different based on the modifier of half/whole section for the pizza, and also varies based on the modifier for pizza size.

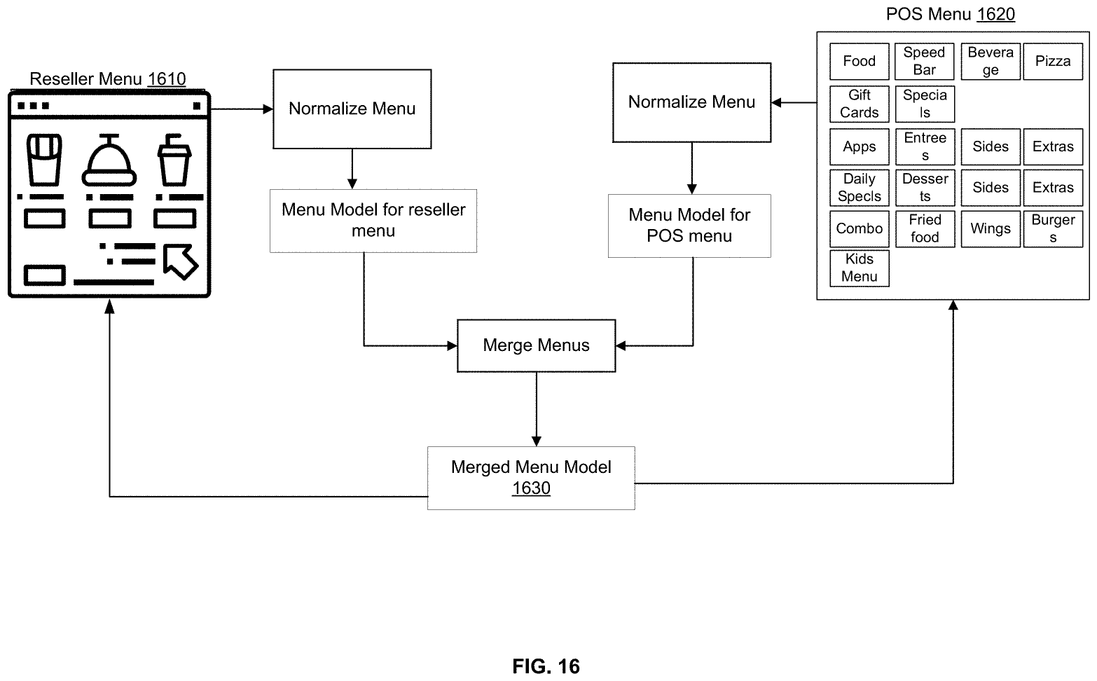

In exemplary embodiments of the present disclosure, a hierarchical catalog model generated from a POS catalog may be merged with a hierarchical catalog model generated from a merchant catalog to create a merged catalog model 1630, as depicted in the exemplary flowchart of FIG. 16 for a restaurant industry specific implementation. This process may occur by system 1220 of FIG. 12.

As shown in exemplary FIG. 16, a reseller menu 1610 is retrieved and normalized into the hierarchical data structure referenced above to create a menu model (such as catalog model 300 of FIG. 3) for the reseller menu 1610. Similarly, a POS menu 1620 is retrieved and normalized into the hierarchical data structure referenced above to create a menu model for the POS menu. The two menus are then merged to create a merged menu model 1630 that is representative of both reseller menu 1610 and POS menu 1620. The merged menu model may be utilized by the system for creating catalog maps 1220 to create a master catalog.

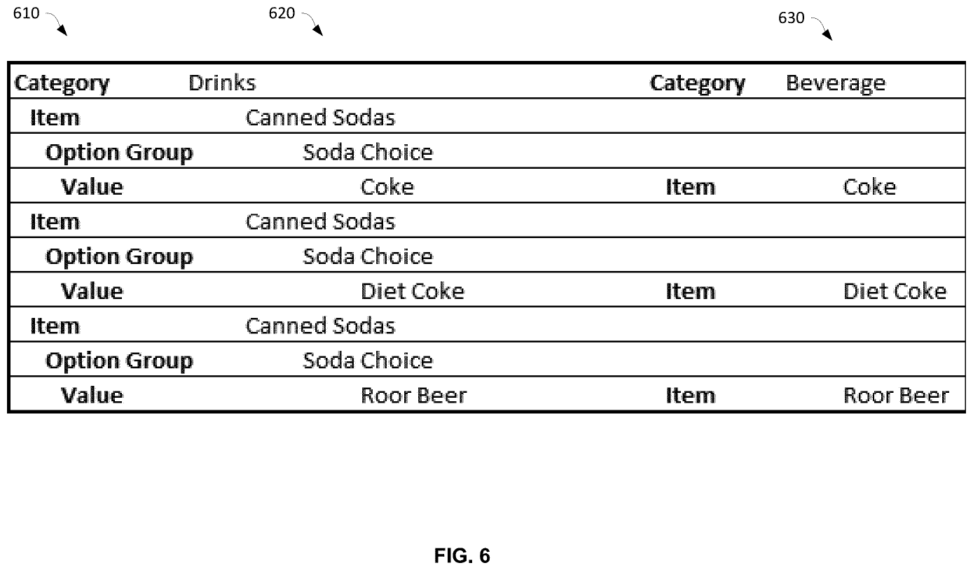

FIG. 15 depicts an exemplary structure of a master catalog 1510 that may be created by system 1220 from a merged catalog model, such as merged menu model 1630 of FIG. 6. The master catalog 1510 may have a category, item, option group, and option value, as the hierarchical catalog model. The master catalog 1510 may also have a modifier group and a modifier value. The modifier group and modifier value may each relate to any of a catalog item, option group, or option value. Further, master catalog 1510 may have one or more sections and section values relating to a category, item, or option value of the master catalog.

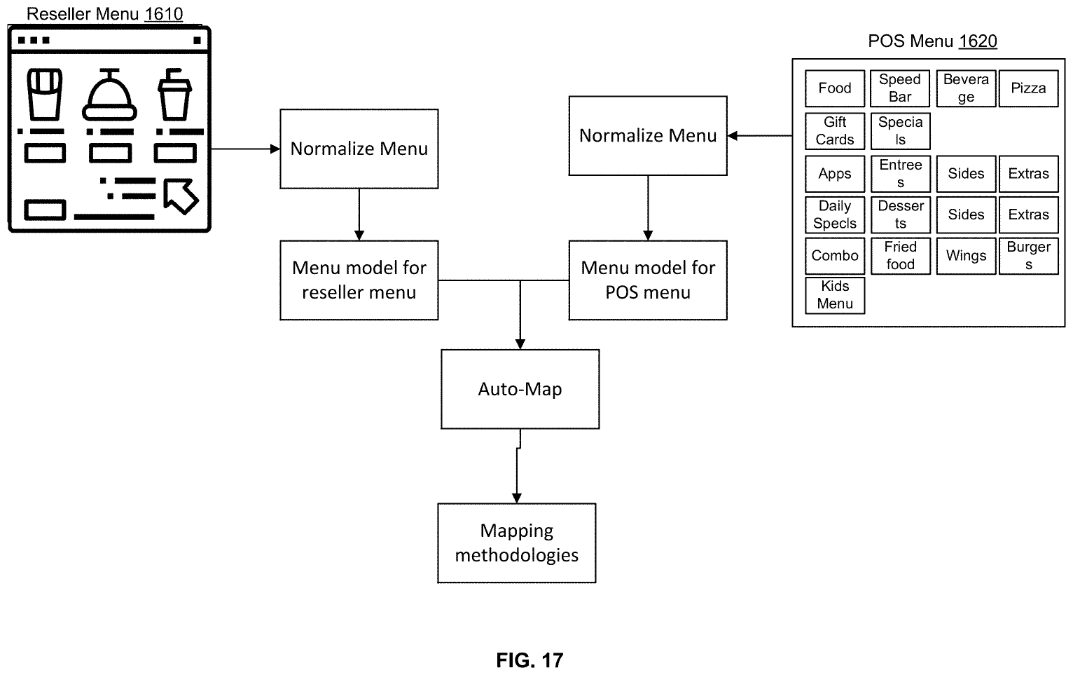

FIG. 17 depicts an exemplary methodology for automatically creating a catalog map for a restaurant industry specific implementation. As shown in the exemplary figure, a reseller menu 1610 is retrieved and normalized into the hierarchical data structure referenced herein to create a menu model (in the form of catalog model 300 of FIG. 3) for the reseller menu 1610. Similarly, a POS menu 1620 is retrieved and normalized into the hierarchical data structure referenced above to create a menu model for the POS menu 1620. Each menu model is then utilized to automatically create a menu map with two columns. Mapping methodologies discussed herein are then used to determine mappings of specific items from each menu.

To create a catalog map, there are four different types of mapping methodologies that may be used to map an online order to a POS order. Any one or more mapping methodology may be utilized in exemplary embodiments. Each of these mapping types will be discussed in more detail herein.

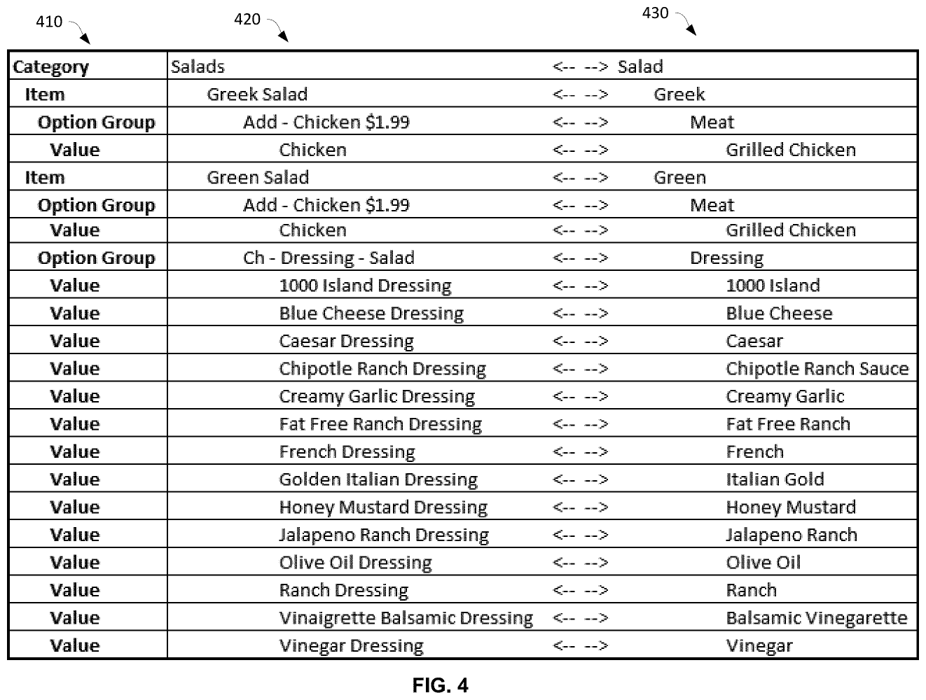

FIG. 4 depicts an exemplary embodiment of one to one mapping for restaurant menus, starting from an auto-map that may be created using the methodology of FIG. 17. In other embodiments, a many to many mapping may be performed in a similar manner. As shown in exemplary FIG. 4, the catalog model hierarchical structure is provided in column 410 on the left side, the online ordering company menu is provided in a center column 420 and a POS menu is provided in a right column 430. As would be understood by persons of ordinary skill in the art, each of these column may be presented in a different order then is shown in the exemplary figure, or presented in a format other than columnar.

In one to one mapping, menu terms that are on a given row are mapped to each other. So, a category of salads in column 420 for the online menu is mapped to a category of salad in column 430 for the POS system. In the subsequent row, a specific item of ‘Greek Salad’ in column 420 is mapped to the word ‘Greek’ on the POS side. This system continues down the rows such that for everything in column 420, there is a match to something in column 430, even though the specific text may not be identical. Using artificial intelligence and machine learning techniques, the term “salads” can be equated with the term “salad”. Further, the term “Greek salad” can be determined to map to the term “Greek” since Greek is a category of salad.

Exemplary FIG. 4 also depicts that “Add Chicken” in column 420 is mapped to ‘Meat’ in column 430 as an option group. This is determined because the terms share a parent (Item for Green Salad) and/or grandparent (Category of Salads) in the hierarchical model. Thus, the mapping of add chicken to meat is determined to be strong. Further, the children option values of chicken and grilled chicken have a strong correlation. Thus, an inference can be made that ‘add chicken’ option group is to be mapped to ‘meat’ option group. That is, given that the ancestors and children in the hierarchy are strong matches, the system can infer that the siblings are also a match. As part of the artificial intelligence applied, these mapping rules can be defined and delineated to determine ways of deciding when a given rule applies to a specific situation.

Exemplary FIG. 4 also depicts that ‘vinaigrette balsamic dressing’ in column 420 is mapped to ‘balsamic vinegarette’ in column 430 as an option group. The name of the dressing is spelled wrong in the POS system menu in column 430. In fact, it is spelled with ‘vinegar’ in the name, and ‘vinegar’ is another option value available in POS menu depicted in column 430. Thus, when the system is mapping balsamic vinaigrette dressing on the left hand side, it can determine that the right hand side has both ‘vinegarette’ and ‘vinegar’, both of which are similar. Thus, it can rely mainly on the ‘balsamic’ part of the phrase in column 420, and a relatively close match between vinaigrette spelled correctly and vinegarette spelled incorrectly in order to decide that is a stronger map than to “vinegar” which is on the row below.

In this way, strings of characters are compared between the online menu in column 420 and POS menu in column 430. ID numbers assigned to individual categories, items, option groups, and option values in the POS system have no correlation whatsoever by themselves to ID numbers assigned to these entities in the online menu. Thus, the mapping of the two menus is originally accomplished by comparison of the character strings that exist on each side. Once the menu map is created for these two menus in the format of the catalog model 300, then the ID numbers from the online menu in column 420 can be correlated to the ID numbers in the POS menu in column 430. This correlation or mapping of ID numbers can then be stored in a database or other data structure (such as storage unit 1291 of FIG. 12). In some embodiments, storage unit 1291 may be remotely accessible by the POS system.

Once a catalog map is created initially for a pair of catalogs, then that map can be utilized in all future instances to fulfill customer orders. That is, a person may place an order with a third-party ordering service for fulfillment of a ‘green salad’ with ‘vinegar dressing’. The order is received by the cataloging and order processing system 1290, acting as an intermediary between the third-party ordering service and the merchant. The cataloging and order processing system 1290 can then utilize a previously generated catalog map to determine an ID number for each of the items in the order, determine a corresponding ID number for each of these items in the merchant POS system, convert the order to a POS order, allowing the merchant to prepare and charge the customer appropriately, thereby fulfilling the customer order with 100% accuracy.

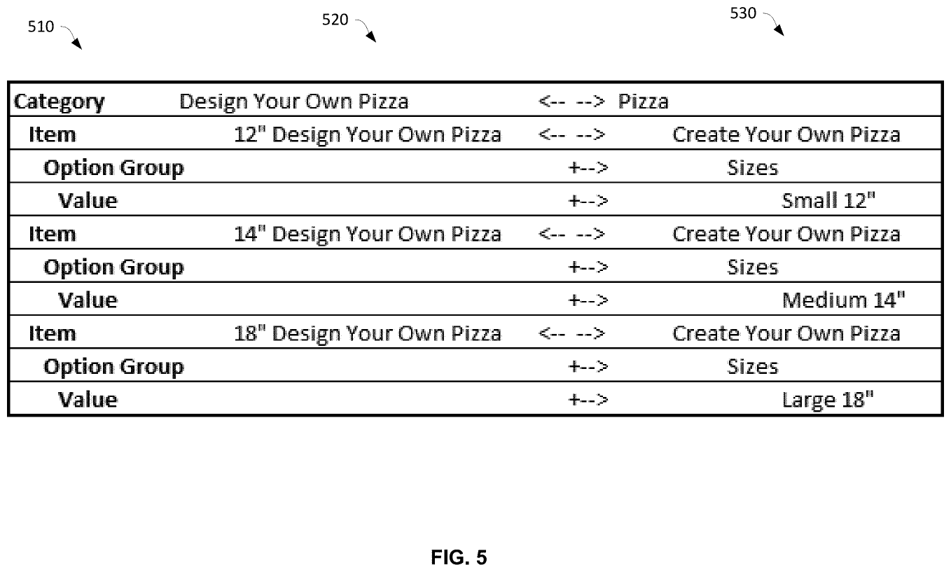

FIG. 5 depicts an exemplary embodiment of one-to-many mapping. In the exemplary figure, the catalog model hierarchical structure is provided in column 510 on the left side, the online ordering company menu is provided in a center column 520, and a POS menu is provided in a right column 530. As would be understood by persons of ordinary skill in the art, each of these column may be presented in a different order then is shown in the exemplary figure, or presented in a format other than columnar.

In one to many mapping, menu terms that are on a given row in one menu (such as the online menu in column 520) are mapped to menu terms that appear on multiple rows in the other menu (such as the POS menu in column 530). As depicted in exemplary FIG. 5, the menu item of ‘12″ Design Your Own Pizza’ from column 520 depicting online menu is mapped to the menu item ‘Create Your Own Pizza’, the option group ‘Sizes’, and also the option value ‘Small 12″’ from the POS system menu shown in column 530.

Thus, in the online menu, the size of the pizza is in the definition of the menu item itself. In the online menu, a 12 inch pizza is a different menu item than a 14 inch pizza, which is a different item than an 18 inch pizza. As such, each of these menu items has a different ID number. However, in the POS system menu, all of these correlate to a singular menu item of ‘Create Your Own Pizza’ and the differences lie in the option values. Thus, the three menu items having three separate ID numbers in the online menu correlate to one menu item ID number in the POS system.

To create the mapping, the system first determines that “design your own pizza” means the same thing as “pizza” at the category level. Then, at the item level, the system determines that very same string “design your own pizza” maps to “create your own pizza”. Further, the system determines that the “12 inches” that is left over in the name of the item in column 520 has to get carried down to the children of sizes and small 12 inch in column 530.

In this exemplary embodiment, the system for creating catalog maps 1220 would recognize that it is not a perfect match, but a strong match to “your own pizza”. The system would then look at the strength of that strong match and compare to the pieces that are not the same—‘design’ on the left side and ‘create’ on the right side. The system would further look to see if there are any better matches between the left hand side and the right hand side. If none better, then the system determines that the two strings are to be mapped to one another.

FIG. 6 depicts an exemplary embodiment of many to one mapping. In the exemplary figure, the catalog model hierarchical structure is provided in column 610 on the left side, the online ordering company menu is provided in a center column 620, and a POS menu is provided in a right column 630. As would be understood by persons of ordinary skill in the art, each of these columns may be presented in a different order then is shown in the exemplary figure, or presented in a format other than columnar.

In many to one mapping, menu terms that appear on multiple rows in one menu (such as online menu) depicted in column 620 are mapped to a single menu term in a second menu (such as POS menu) depicted in column 630.

As depicted in exemplary FIG. 6, the online ordering menu is structured such that canned soda is an item with an option group of soda and an option value of ‘coke’. In contrast, the POS menu in column 630 simply depicts an item of ‘coke’. In correlating the online menu to the POS menu, multiple ID numbers are mapped to one ID number. Thus, when are order comes in from the online ordering company, that order will refer to ‘canned sodas’ by ID, soda choice by an ID, and coke by an ID. When the POS system at the restaurant receives all three of those IDs, then and only then can it find a match in the menu map that points to ‘coke’ as the corresponding menu item on the POS side. Since there are 4 levels in the hierarchical catalog model 300, there may be anywhere from 1-4 IDs from the online ordering company that match to a single ID on the POS side. However, other embodiments may have fewer or additional levels in a hierarchical catalog model, thus leading to a different number of IDs from an online ordering company to match to a single ID on the POS side.

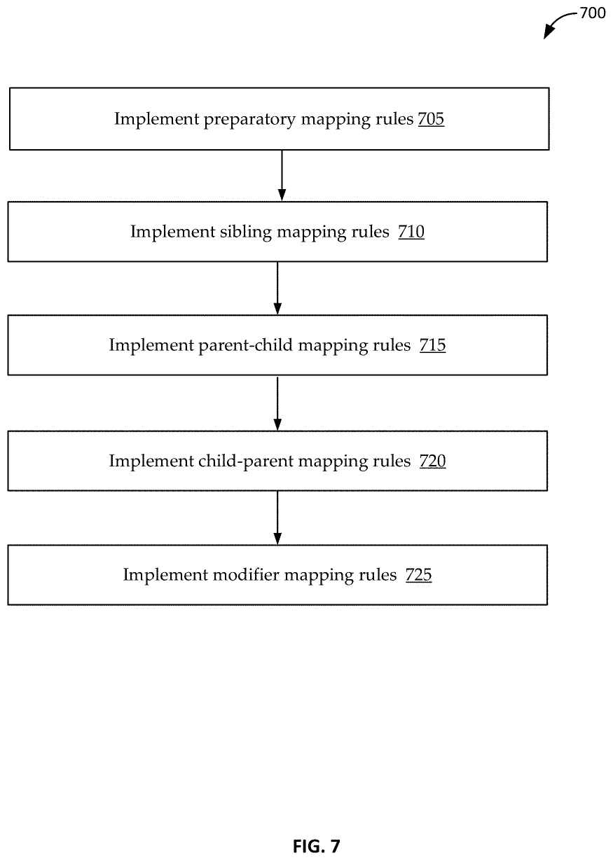

In accomplishing the creation of the catalog map in the format of the hierarchical catalog model as discussed herein, the system implements a series of mapping rules in sequence. FIG. 7 depicts an exemplary sequence of mapping rules that may be employed. First the system implements preparatory rules in step 705, which are fairly simple algorithms that are applied as a first pass to prepare for upcoming, more complicated mappings. As part of the preparatory rules, the system may first convert all text in both catalogs to be compared to lowercase script. Further, the system may convert one or more words that are in plural form to the singular versions.

The system further determines the different parts of speech that are present for semantic based matching, since words are linked differently depending on the part of speech. For example, proper nouns have highest priority for matching, then improper nouns are second priority for matching, and then verbs are matched.

Once the preparatory rules have been applied, then sibling rules may be applied in step 710 for pattern (or string) based mapping. In exemplary embodiments, an exact match from a sibling on the left side to a sibling on the right side is the most desirable outcome. If that does not exist, then an exact match between a sibling on the left side to one or more substrings from a sibling on the right is sought. As discussed herein, a ‘string’ or ‘substring’ refers to characters, and not words.

A third sibling rule specifies that one or more sibling substrings on the left are an exact match to a single substring on the right side. A fourth sibling rule specifies that a substring on the left exactly matches a substring on the right. That is, there may exist the same words on the left and right side, but in a different order and with no characters left over (all characters matched).

These sibling rules, and any others not specifically mentioned here, may be applied in any order. Further, the system may implement a subset of the sibling rules, instead of all of them, in varying order.

Parent-child rules are also implemented by the system to ascertain a catalog map, in step 715. In various embodiments, the parent-child rules encompass any one or more of the four sibling rules discussed above, in addition to any other rules. The parent-child rules relate to matches of strings or substrings up and down the tree of the hierarchical catalog model, for structure based mapping. Since the catalog model contains four levels in exemplary embodiments discussed herein, the matches for the parent-child rules may be found within three levels up or down from a catalog on the other side.

Child-parent mapping rules are also implemented by the system to ascertain a catalog map, in step 720. In various embodiments, the child-parent rules encompass any one or more of the sibling rules discussed above, in addition to any other rules. The child-parent rules relate to matches of strings or substrings up and down the tree of the hierarchical catalog model. Since the catalog model contains four levels in exemplary embodiments discussed herein, the matches for the child-parent rules may be found within three levels up or down from a catalog on the other side.

Modifier rules may also be implemented by the system to ascertain a catalog map, in step 725. The modifier rules are applicable to modifiers identified in a catalog, and not entities of the hierarchical catalog model. For example, a modifier might be a size of an item (such as a fountain drink, pizza, etc.). Further, for the special case of pizza, the right and left side of the pizza may have different toppings. The designation of the different toppings for the different sides of the pizza are a special instance of modifier rules called Sections, and not rules relating to items or options.

With the mapping rules discussed herein, the system compares terms from one catalog (depicted in the exemplary figures as being in a left side column) with terms from a second catalog (depicted in the exemplary figures as being in a right side column). The catalog terms may be for a category, item, option group, option value, or modifier. All possible combinations are compared, and a weighted score is determined. For any two terms compared, the top weighted score is selected and utilized for the catalog map.

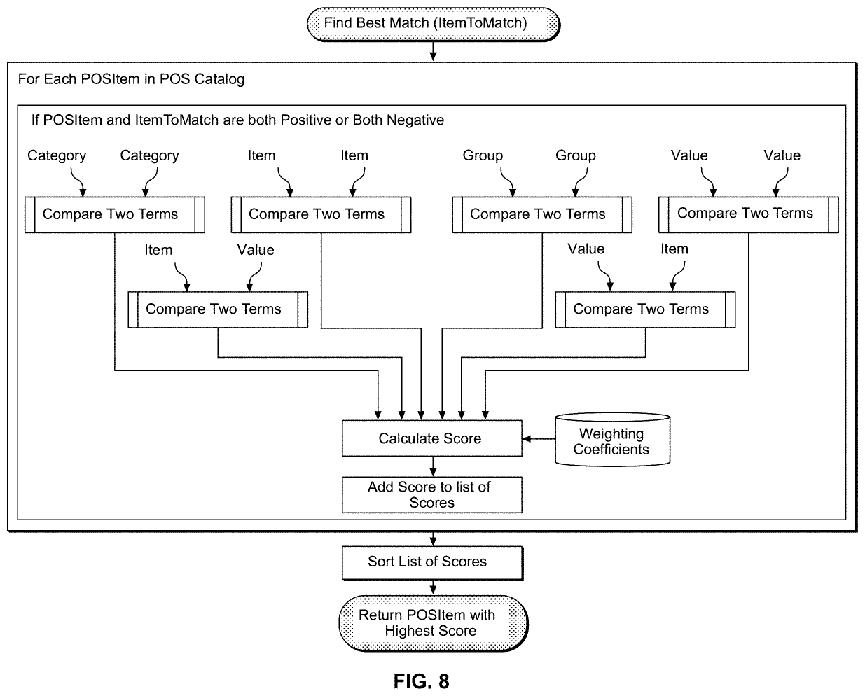

FIG. 8 illustrates an exemplary process utilized by the system disclosed herein to find a best match between a term on one catalog with a term on a second catalog. As depicted in the figure, a determination is made if the POS term and term to match are both positive or both negative. This is important because it is imperative that a string of ‘add onions’ is not equated or matched with a string of ‘no onions’, regardless of a matching score. The string ‘add onions’ is an example of a positive term, and the string ‘no onions’ is an example of a negative term. Thus, the system compares terms that are either both positive or both negative, regardless of how close they might be based on any scoring. If a catalog item does not have either a positive or negative string attached to it, then this step is not applicable.

For each category, item, option group, and option value, the two terms are compared. In exemplary embodiments, one or more of the mapping rules are utilized. As used in FIG. 8, the compared “terms” may be a category, item, option, or option value, but may also include descriptions, prices, and any other metadata associated with a catalog. For example, metadata may include associated photos that by image classification algorithms introduce additional information into the matching process.

The comparison of catalog terms is particularly important because sometimes a term may be used in different categories. In one example, the word ‘Italian’ may be used as an option in an option group called dipping sauce when accompanied with a catalog item such as a pretzel roll or breadstick. The same word ‘Italian’ may also be used as an option in an option group for salad dressing. The ‘Italian’ sauce may in fact be the same ingredients in both categories. However, the POS system may differentiate the two because there is a different price for Italian as a salad dressing as opposed to Italian as a smaller quantity when it's a dipping sauce. Thus, the system can allow the ‘Italian’ text string to be differentiated where it needs to be differentiated, but possibly matched where it needs to match.

From the comparisons of terms, a score is calculated for the match, utilizing weighting coefficients for select terms or types of terms. The calculated score is then added to a list of scores, which is sorted. In exemplary embodiments, the weighted score is a numerical value between 0 and 1, with 1 denoting an exact match and 0 denoting no match. The POS item with the highest score is determined to be the match to the item from the online catalog, and is added to the catalog map for this combination of two catalogs. In this way, each item in an online catalog is mapped to POS system items.

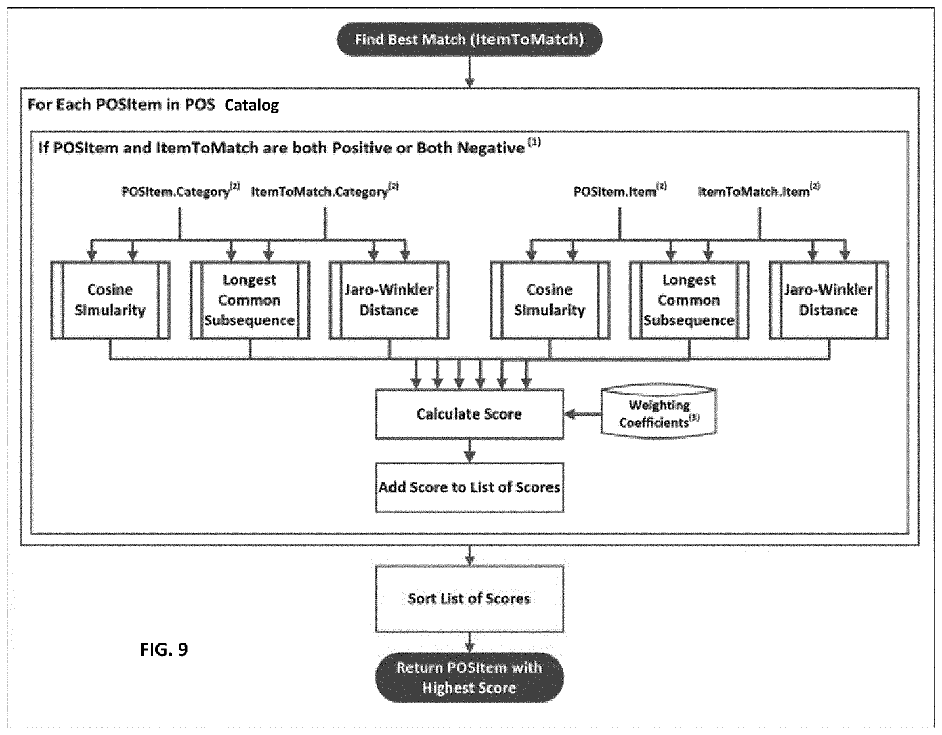

FIG. 9 illustrates an exemplary process utilized by the system disclosed herein to continue to find a best match between a term on one catalog with a term on a second catalog. As depicted in the figure, a determination is made if the POS term and term to match are both positive or both negative, as in FIG. 8. For each category, item, option group, and option value, the two terms are compared. In exemplary embodiments, one or more of the mapping rules are utilized and one or more algorithms are implemented for the mapping rules, such as cosine similarity, longest common subsequence, and Jaro-Winkler distance.

From the comparisons of terms, a score is calculated for the match, utilizing weighting coefficients for select terms or types of terms. The calculated score is then added to a list of scores, which is sorted. In exemplary embodiments, the weighted score is a numerical value between 0 and 1, with 1 denoting an exact match and 0 denoting no match. The POS item with the highest score is determined to be the match to the item from the online catalog, and is added to the catalog map for this combination of two catalogs. In this way, each item in an online catalog is mapped to POS system items.

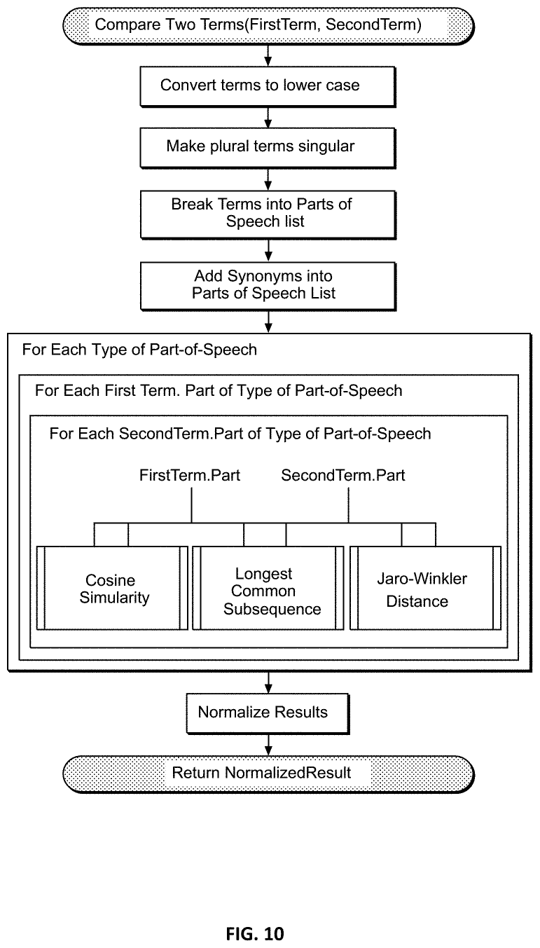

An exemplary process of comparing terms is shown in FIG. 10. The system first converts all terms to lower case and makes plural terms singular. Then terms are broken into a parts of speech list to identify all of the grammatical parts of speech that are present. Synonyms are also added into the parts of speech list. An item may be listed as ‘hamburger’ in one catalog, ‘burger’ in another, ‘Delux Burger’ at one merchant, and ‘The Big Kahuna’ at another. Synonyms are utilized by the system to bring in all these matchings that are not going to happen without prior knowledge that these catalog terms mean the same thing.

Each individual part of speech in a first term is compared to the same part of speech type in a second term. For example, the system compares all of the nouns in the first term to all of the nouns in the second term, all of the adjectives in the first term to all of the adjectives in the second term, proper nouns, and so on for all of the parts of speech present. In this way, a comparison is made of like to like. A cosine similarity algorithm may be utilized to implement this analysis, since it is a measure of the number of identical characters regardless of order. A longest common subsequence algorithm measures identical characters in sequence, but not necessarily the same order.

Jaro-Winkler distance algorithms measure identical characters within a limited distance of each other, weighted to the beginning of the string being more important than the end of the string. Additional screening algorithms may also be implemented in addition to, or instead of, these algorithms specifically depicted in the exemplary figure.

The specific mapping rules dictate the pattern, structure, and semantic matching algorithms that are most appropriate for implementing that rule, so a different algorithm can be used for each mapping rule. A determination is made by the system as to which algorithm is appropriate for the mapping rule that we are applying to the strings that are currently being analyzed. For example, Smith Waterman algorithm does a very good job of identifying identical strings. Combining that with Chapman algorithms tells you whether there are any characters left over that are not a part of the exact match. Thus, that combination of algorithms is better than simply using cosine similarity, LCS, or Jaro-Winkler for identifying identical character strings and determining if any unmatched characters remain in the string.

Although not explicitly illustrated in FIG. 10, the semantic-based mapping module relies on the Natural Language Processing technique of word embedding that uses a neural network model to learn word associations from a very large corpus of text. In one embodiment, the Wikipedia English language database is utilized. The neural network model is used to convert words or phrases into vectors of real numbers based on the corpus, and those vector representations of words or phrases are then used to compute their score of semantic similarities using the cosine similarity algorithm.

The results of the various algorithms applied may then be normalized and a normalized result is returned. In exemplary embodiments, the normalized result is a score that is a numerical value between 0 and 1, with 1 denoting an exact match and 0 denoting no match.

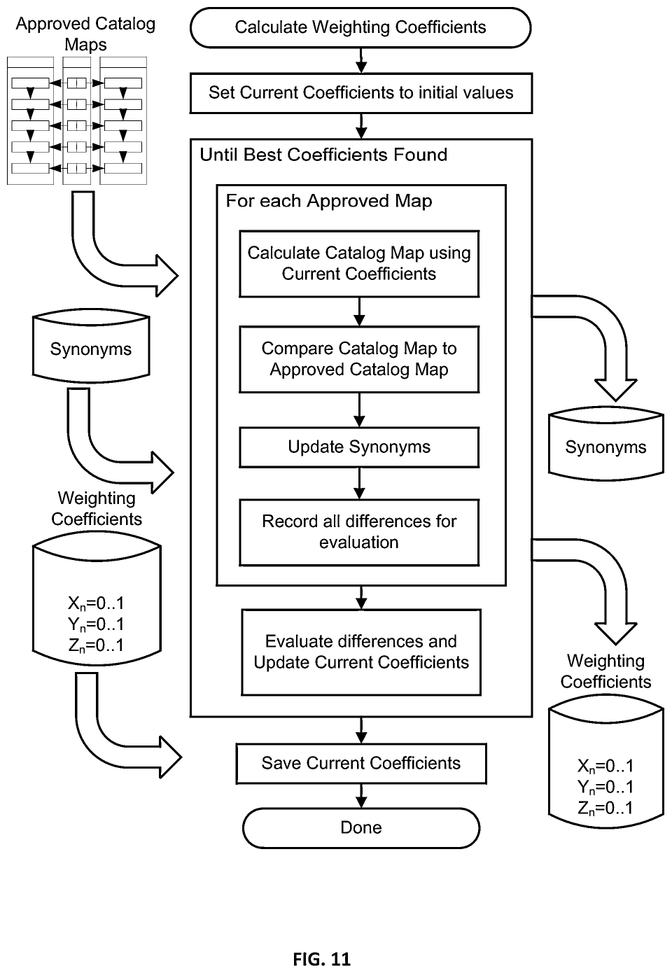

FIG. 11 depicts an exemplary machine learning process utilized by the system to automatically create a catalog map between two different catalogs for a same merchant. A catalog map cannot be utilized by a merchant to fulfill customer orders until it is 100% accurate. Thus, in some instances, a human administrator reviews a catalog map automatically created by the system 1220 and modifies matchings as necessary until the map is 100% accurate. Once a catalog map is created between a POS catalog and a third-party online catalog and determined to be 100% accurate, that map can then be used to train a machine learning algorithm to automatically create additional catalog maps between the POS catalog and other third-party online catalogs with increased accuracy.

One part of training the machine learning algorithm for automatically creating a catalog map is the determination of the weighting coefficients that are used. Exemplary FIG. 11 depicts that weighting coefficients are initially set to an initial value. Each time an approved catalog map is checked into a database of the system, this machine learning algorithm is run. This means that until a better set of coefficients is determined, the system will go through all of the approved catalog maps and calculate a new catalog map using the current set of coefficients. Any new catalog maps generated are compared with a previously approved catalog map. From this comparison, the system updates any synonyms that may be extracted from that process, records all of the differences and then uses those differences as a mechanism for updating the current coefficients. The process continues until a better result is achieved for a catalog map. When the better result is achieved, that catalog map is saved for use in a creation of a subsequent catalog map.

In this way, the machine learning algorithm for automatically creating catalog maps is essentially retrained with every approved catalog map ever built, through this iterative process. Further, a catalog may be dynamic, with seasonal offerings, limited time offerings of new items, or items going out of stock. Thus, the system may have to re-evaluate a merchant catalog on a periodic basis using some or all of the historical approved catalog maps previously generated for that merchant. In exemplary embodiments, the periodic basis may be once a day, once a week, once a month, once a quarter, once a year, or upon direction by a human administrator.

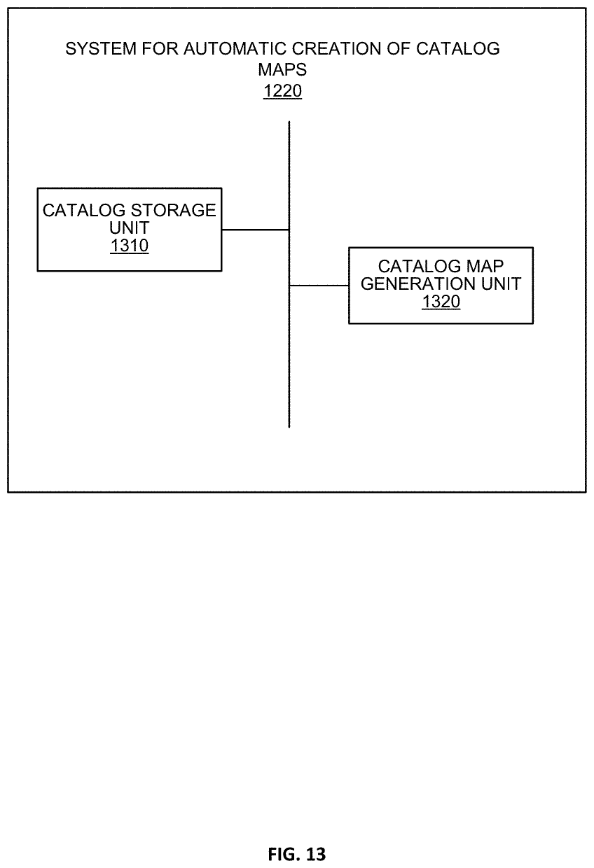

FIG. 13 is a block diagram illustrating select components of system 1220, as discussed with reference to FIG. 12. The system 1220 may comprise a (temporary) catalog storage unit 1310 to store a catalog from a merchant point-of-sale system, and/or from one or more third-party services, provided by system 1290. The system 1220 may also comprise a catalog map generation unit 1320, which is configured to utilize machine learning techniques to analyze the provided catalogs and generate a catalog mapping between the provided catalogs.

In exemplary embodiments, the catalog map generation unit 1320 may retrieve from catalog storage unit 1310 a multi-tier hierarchical model for the extracted third-party catalog, retrieve from catalog storage unit 1310 a multi-tier hierarchical model for the extracted merchant catalog, compare at least one term from the extracted third-party catalog with at least one term from the extracted merchant catalog, determine an equivalence between two compared terms, generate a catalog map in the hierarchical model structure with each item on the third-party catalog mapped to a corresponding item on the merchant catalog, and save the catalog map in data structure 1280. Further, the catalog map generation unit 1320 is configured to generate a master catalog in the hierarchical model structure with each item on a third party catalog merged with a corresponding item on the merchant catalog.

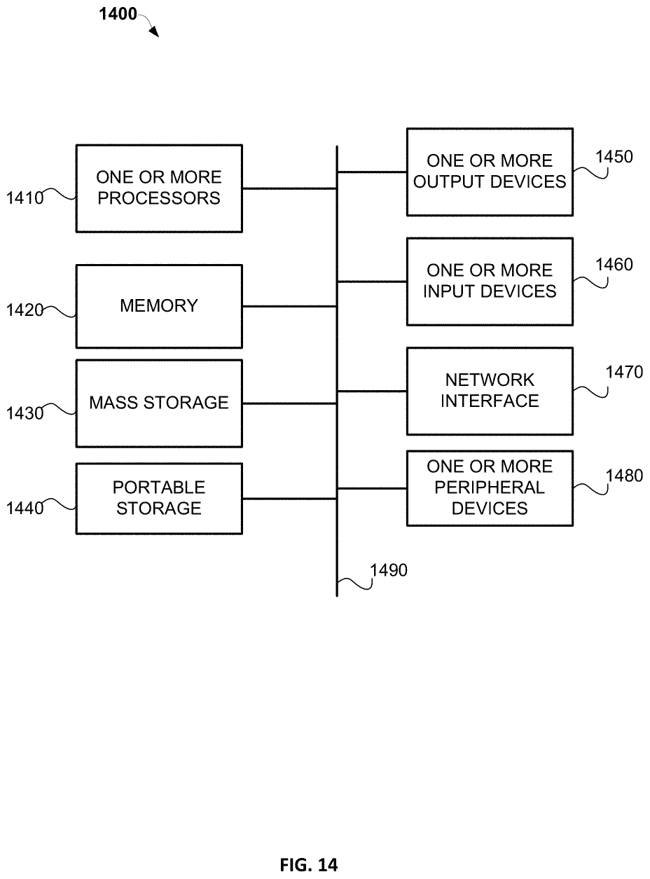

FIG. 14 illustrates an exemplary computing system 1400 that may be used to implement embodiments described herein, such as system 1220, system 1290, and POS system 1230. The exemplary computing system 1400 of FIG. 14 may include one or more processors 1410 and memory 1420. Memory 1420 may store, in part, instructions and data for execution by the one or more processors 1410. Memory 1420 can store the executable code when the exemplary computing 1400 is in operation. The exemplary computing system 1400 of FIG. 14 may further include a mass storage 1430, portable storage 1440, one or more output devices 1450, one or more input devices 1460, a network interface 1470, and one or more peripheral devices 1480.

The components shown in FIG. 14 are depicted as being connected via a single bus 1490. The components may be connected through one or more data transport means. The one or more processors 1410 and memory 1420 may be connected via a local microprocessor bus, and the mass storage 1430, one or more peripheral devices 1480, portable storage 1440, and network interface 1470 may be connected via one or more input/output buses.

Mass storage 1430, which may be implemented with a magnetic disk drive, an optical disk drive, and/or solid state disks (SSD) is a non-volatile storage device for storing data and instructions for use by a magnetic disk or an optical disk drive, which in turn may be used by one or more processors 1410. Mass storage 1430 can store the system software for implementing embodiments described herein for purposes of loading that software into memory 1420.

Portable storage 1440 may operate in conjunction with a portable non-volatile storage medium, such as a compact disk (CD) or digital video disc (DVD), to input and output data and code to and from the computing system 1400 of FIG. 14. The system software for implementing embodiments described herein may be stored on such a portable medium and input to the computing system 1400 via the portable storage 1440.

One or more input devices 1460 provide a portion of a user interface. The one or more input devices 1460 may include an alphanumeric keypad, such as a keyboard, for inputting alphanumeric and other information, or a pointing device, such as a mouse, a trackball, a stylus, or cursor direction keys. Additionally, the computing system 1400 as shown in FIG. 14 includes one or more output devices 1450. Suitable one or more output devices 1450 include speakers, printers, network interfaces, and monitors.

Network interface 1470 can be utilized to communicate with external devices, external computing devices, servers, and networked systems via one or more communications networks such as one or more wired, wireless, or optical networks including, for example, the Internet, intranet, LAN, WAN, cellular phone networks (e.g., Global System for Mobile communications network, packet switching communications network, circuit switching communications network), Bluetooth radio, and an IEEE 802.11-based radio frequency network, among others. Network interface 570 may be a network interface card, such as an Ethernet card, optical transceiver, radio frequency transceiver, or any other type of device that can send and receive information. Other examples of such network interfaces may include Bluetooth®, 3G, 4G, and Wi-Fi® radios in mobile computing devices as well as a USB.

One or more peripheral devices 1480 may include any type of computer support device to add additional functionality to the computing system. The one or more peripheral devices 1480 may include a modem or a router.

The components contained in the exemplary computing system 1400 of FIG. 14 are those typically found in computing systems that may be suitable for use with embodiments described herein and are intended to represent a broad category of such computer components that are well known in the art. Thus, the exemplary computing system 1400 of FIG. 14 can be a workstation, server, minicomputer, mainframe computer, or any other computing device. The computer can also include different bus configurations, networked platforms, multi-processor platforms, and so forth. Various operating systems (OS) can be used including UNIX, Linux, Windows, and other suitable operating systems.

In further embodiments, the disclosed system (such as system 1220, system 1290, and POS system 1230) operate on a network of high-performance computing servers typically found in a hosted environment, such as Microsoft Azure, Amazon Web Services, Google Cloud, etc.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a central processing unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as RAM. Transmission media include coaxial cables, copper wire, and fiber optics, among others, including the wires that include one embodiment of a bus. Transmission media can also take the form of acoustic or light waves, such as those generated during radio frequency and infrared data communications. Some forms of computer-readable media include, for example, a hard disk, magnetic tape, any other magnetic medium, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Thus, various embodiments of methods and systems for automatically creating a catalog map for reconciliation of a point-of-sale catalog and a third-party service catalog have been described. Although embodiments have been described with reference to specific examples, it will be evident that various modifications and changes can be made to these example embodiments without departing from the broader spirit and scope of the present application. Accordingly, the specification and drawings are to be regarded in an illustrative rather than a restrictive sense. There are many alternative ways of implementing the present technology. The disclosed examples are illustrative and not restrictive.

What is claimed is:

1. A system for automatic creation of a catalog map between a third-party catalog and a merchant catalog in a point-of-sale system, the system comprising:
a catalog extraction unit configured to execute instructions stored on a processor to:
extract a third-party catalog for a merchant from a third-party service; and
extract a merchant catalog from a merchant point-of-sale system; and
a catalog map creation unit configured to execute instructions stored on a processor to:
build a multi-tier hierarchical model for the extracted third-party catalog;
build a multi-tier hierarchical model for the extracted merchant catalog;
compare at least one term from the extracted third-party catalog with at least one term from the extracted merchant catalog;
determine an equivalence between two compared terms; and
generate a catalog map in the multi-tier hierarchical model structure with each item on the third-party catalog mapped to a corresponding item on the merchant catalog.

2. The system of claim 1, wherein the catalog map creation unit is further configured to generate a master catalog in the multi-tier hierarchical model structure with each item on the third-party catalog merged with a corresponding item on the merchant catalog.

3. The system of claim 1, wherein the multi-tier hierarchical model has four tiers.

4. The system of claim 1, wherein the extracted term is any string of characters.

5. The system of claim 1, wherein the catalog map further comprises an identifier for each item on the merchant catalog and a corresponding identifier for each item on the third-party catalog.

6. The system of claim 1, wherein the catalog map creation unit is further configured to receive input from a human user regarding a mapping between an item on the third-party catalog to an item on the merchant catalog.

7. The system of claim 1, wherein the comparison of the terms further comprises comparing one tier from the merchant catalog with one tier from the third-party catalog.

8. The system of claim 1, wherein the comparison of the terms further comprises comparing one tier from the merchant catalog with multiple tiers from the third-party catalog.

9. The system of claim 1, wherein the comparison of the terms further comprises comparing multiple tiers from the merchant catalog with one tier from the third-party catalog.

10. The system of claim 1, wherein the comparison of the terms further comprises determining that both terms have a positive meaning or that both terms have a negative meaning.

11. The system of claim 1, wherein the determining the equivalence between the two compared terms further comprises determining a weighted score representing a degree of equivalence between the two compared terms.

12. The system of claim 1, wherein the determining the equivalence between the two compared terms further comprises utilizing at least two different analyses to generate at least two weighted scores representing a degree of equivalence between the two compared terms.

13. The system of claim 1, wherein the generate the catalog map further comprises utilizing at least one previously generated catalog map between the merchant catalog and a second third-party catalog.

14. A method for automatically creating a catalog map between a third-party catalog and a merchant catalog, the method comprising:
extracting a third-party catalog for a merchant from a third-party service;
extracting a merchant catalog from a merchant point-of-sale system;
building a multi-tier hierarchical model for the extracted third-party catalog;
building a multi-tier hierarchical model for the extracted merchant catalog;
comparing at least one term from the extracted third-party catalog with at least one term from the extracted merchant catalog;
determining an equivalence between two compared terms; and
generating a catalog map in the hierarchical model structure with each item on the third-party catalog mapped to a corresponding item on the merchant catalog.

15. The method of claim 14, wherein the catalog map further comprises an identifier for each item on the merchant catalog and an identifier for each item on the third-party catalog.

16. The method of claim 14, wherein the comparison of the terms further comprises determining that both terms have a positive meaning or that both terms have a negative meaning.

17. The method of claim 14, wherein the comparison of the terms further comprises utilizing at least one of a Jaro-Winkler Distance analysis, Longest Common Subsequence analysis, and Cosine Similarity analysis.

18. The method of claim 14, wherein the determining the equivalence between the two compared terms further comprises determining a weighted score representing a degree of equivalence between the two compared terms.

19. The method of claim 14, wherein the generating the catalog map further comprises utilizing at least one previously generated catalog map between the merchant catalog and a second third-party catalog.

20. A method for automatically creating a master catalog between one or more third-party catalogs and a merchant catalog, the method comprising:
extracting a third-party catalog for a merchant from one or more third-party services;
extracting a merchant catalog from a merchant point-of-sale system;
building a multi-tier hierarchical model for the extracted third-party catalogs;
building a multi-tier hierarchical model for the extracted merchant catalog;
distinguishing between modifiers and options in the extracted third-party catalog;
distinguishing between modifiers and options in the extracted merchant catalog;
comparing at least one term from the extracted third-party catalog with at least one term from the extracted merchant catalog;
determining an equivalence between two compared terms; and
generating a master catalog in the multi-tier hierarchical model structure with each item on each third-party catalog merged with a corresponding item on the merchant catalog.

21. A system for automatic creation of a master catalog between at least one third-party catalog and a merchant catalog in a point-of-sale system, the system comprising:
a catalog extraction unit configured to execute instructions stored on a processor to:
extract a third-party catalog for a merchant from at least one third-party service; and
extract a merchant catalog from a merchant point-of-sale system; and
a catalog map creation unit configured to execute instructions stored on a processor to:
build a multi-tier hierarchical model for the extracted at least one third-party catalog;
build a multi-tier hierarchical model for the extracted merchant catalog;
distinguish between modifiers and options in the extracted third-party catalog;
distinguish between modifiers and options in the extracted merchant catalog;
compare at least one term from the extracted at least one third-party catalog with at least one term from the extracted merchant catalog;
determine an equivalence between two compared terms; and
generate a master catalog in the multi-tier hierarchical model structure with each item on each third-party catalog merged with a corresponding item on the merchant catalog.
